(19) United States
(12) Patent Application Publication
(10) Pub. No.: US 2009/0312481 A1
(43) Pub. Date: Dec. 17, 2009

(54) POLYVINYL ESTER DISPERSIONS AND THEIR USE

(75) Inventors: MARTIN JAKOB, KELKHEIM (DE); DANIELA HARDT, SULZBACH (DE); HANS-UWE FAUST, LIEDERBACH (DE)

Correspondence Address: DORITY & MANNING, P.A., POST OFFICE BOX 1449, GREENVILLE, SC, 29602-1449, US

(73) Assignee: CELANESE EMULSIONS GMBH, Kronberg/Ts. (DE)

(21) Appl. No.: 12/465,115

(22) Filed: May 13, 2009

(30) Foreign Application Priority Data
May 13, 2008 (DE) 102008023389.7-43

(51) Int. Cl. C09D 167/00; C09J 167/00

(52) U.S. Cl. 524/503; 524/556

(57) ABSTRACT

A description is given of aqueous polyvinyl ester dispersions comprising
a) at least one vinyl ester copolymer derived from at least one vinyl ester of a monocarboxylic acid, at least one ethylenically unsaturated monomer containing N-alkylol groups and/or derivatives of N-alkylol groups, and, if desired, further comonomers,
b) at least one protective colloid,
c) at least one carboxylic acid and/or salt thereof, containing at least one further radical selected from the group consisting of hydroxyl, amino, carboxyl, carboxylic ester, and carboxylic amide radicals, and
d) at least one water-soluble salt of a divalent metal ion.

These dispersions are especially suitable for adhesively bonding porous or semiporous substrates, such as wood. Adhesive bonds of high strength and water resistance can be produced that do not exhibit discoloration. The dispersions can be used more particularly as veneer adhesives.

The present invention relates to polyvinyl ester dispersions with selected crosslinking agents and crosslinking catalysts. It is possible therefrom with preference to formulate aqueous dispersion adhesives whose films exhibit increased water resistance and at the same time a sharply reduced tendency toward heat-induced discoloration. The invention further relates to the preparation of these polyvinyl ester dispersions and also to their use for adhesively bonding or coating any desired substrates, preferably porous and semiporous substrates, such as wood, and more particularly for gluing veneers.

Aqueous polymer dispersions, especially of polyvinyl esters, such as polyvinyl acetate, are used as white glues for bonding wood and other porous substrates. The chemistry of these adhesives, which are extensively produced industrially, has long been part of the patent literature and has been described in numerous technical publications, as for example in Wood Adhesives—Chemistry and Technology, volume 1, chapter 7, Marcel Dekker, New York, 1983.

A subgroup among the polyvinyl ester dispersions with great commercial significance is formed by those whose films have increased water resistance. The susceptibility of adhesive bonds based on polyvinyl ester to water derives very largely from the presence of hydrophilic stabilizers, especially polyvinyl alcohol, which are typically used in the preparation of the adhesive dispersion. One possible way of improving the water resistance, therefore, is to reduce the hydrophilicity of the adhesive by crosslinking the polyvinyl alcohol with reactive compounds, for example. Systems on the market are based on the use of crosslinking comonomers, such as N-methylol(meth)acrylamide, or on the addition of crosslinking resins, polyisocyanates or polyfunctional carbonyl compounds in free or masked form.

Ensuring sufficient reactivity at room temperature frequently necessitates a lowering of the pH through addition of acidic compounds. Certain mechanisms, such as methylol condensation or acetalization, for example, are accelerated by strong Lewis acids. For this reason, for example, acidic salts of aluminum are added as a curing component to the dispersions. In commerce these products are available both in one-component and in two-component form.

A known technical disadvantage of these systems lies in the deficient color neutrality of their films or bonds when exposed to heat or actinic radiation. Consequently the products are of limited suitability for all those applications where bonding is carried out hot, as for example in the case of the gluing of veneers using hydraulic hot presses.

The thermal discoloration is caused partially by the polyvinyl alcohol compound generally used as a protective colloid, in which conjugated double-bond systems form readily in the acidic range under aluminum salt-catalyzed dehydration or dehydroacetoxylation. Under a thermal load, these films readily undergo reddish to dark-brown discoloration at above 100° C. Even at room temperature, yellowing gradually sets in. The effect is disruptively noticeable above all in the bonding of light-colored wood varieties, such as pine.

Moreover, with certain wood constituents, the surface diffusion of the aqueous phase of the dispersion into the substrate gives rise to a discoloration, in which aluminum ions appear to play a part, as a catalyst during the synthesis of the chromophores. The interaction occurs with tree resins or other constituents specific to the wood species. Problem wood varieties are, for example, oak, cedar, robinia, cherry, and maple. In the case of thin cut wood slices, of the kind used for producing veneers, the effect is particularly disruptive.

In the past a number of pathways have been taken to solving this problem.

DE-A 196 49 419 proposes the addition of low molecular mass polyvinyl alcohols having a Höppler viscosity of 2 to 6 mpa*s (4% strength aqueous solution) to the polyvinyl ester dispersion crosslinked with N-methylolacrylamide. This is done using preferably 2% to 7.5% by weight, based on the total weight of the dispersion. In addition it is also possible to add 0.5% to 1% by weight of known complexing agents, EDTA, for example. In the presence of aluminum ions, however, the effect at high temperatures is too weak. Moreover, the high excess of low molecular mass polyvinyl alcohol in the aqueous phase is detrimental to the water resistance, as a result of the automatically reduced crosslinking density.

JP-A 10-121 017 (CA 1998:287070) provides for the use of aluminum sulfate as an alternative to aluminum chloride, phosphoric acid or para-toluenesulfonic acid as a curing agent for an adhesive for producing veneers. The dispersion is composed of a copolymer of vinyl acetate and N-methylolacrylamide. Proposals for the substitution of aluminum are absent.

JP-A 01-229 085 (CA 1990: 79772) proposes, as a veneer adhesive, a mixture of a dispersion based on polyvinyl acetate and an aqueous solution of chelate compound. The compound in question is sodium oxalate, oxalic acid or sodium citrate. The solution approach is of only limited practicability, owing to the inadequate water resistance and the extremely high quantities of chelate compound to be used.

A different path is taken in DE-A 103 29 594. That specification describes an adhesive in a preferably aqueous dispersion form, with a dispersed phase comprising a polymer of an ethylenically unsaturated monomer, and a first dispersion medium comprising a polyvinyl alcohol modified by ethylene units, with an ethylene unit content of below 20 mol %, and with a further vinyl alcohol polymer as an additional dispersion medium. This solution already provides partial satisfaction of the requirements. The thermal color neutrality is achieved as a result of the absence of metal ions, but the solution approach does not envisage a crosslinker system. Therefore, for example, a relevant test standard such as DIN EN 204/D3 is not reliably met without addition of further components which enhance the water resistance, and particularly not in the context of the bonding of problem wood species.

DE 103 35 673 A1 discloses water-resistant dispersion-based adhesives comprising emulsion polymers with a small amount of crosslinkable N-methylol groups and also selective crosslinkers with etherified or partially etherified N-methylol groups. The description observes that, for the purpose of improving the water resistance, further salts or additives, organic and/or inorganic acids or acidic inorganic salts can be used. Examples given of such additives include magnesium chloride, citric acid, glycolic acid, and sodium tetrafluoroborate. Combinations of metal salts with acids are not disclosed. Furthermore, the dispersion-based adhesives described in that document comprise preferably acidic metal salts, such as aluminum chloride hexahydrate, as crosslinkers.

DE 10 2005 057 645 A1 describes polyvinyl ester dispersions with a low film formation temperature and high water resistance. They are characterized by the use of selected film-forming assistants. The description again observes that, for the purpose of improving the water resistance, it is possible to use further salts or additives, organic and/or inorganic acids or acidic inorganic salts. Examples given of such additives include magnesium chloride, citric acid, glycolic acid and sodium tetrafluoroborate. Combinations of metal salts of acids are not disclosed. Dispersion-based adhesives described in that document, moreover, likewise contain preferably acidic metal salts as crosslinkers.

Within the market there is a need for an adhesive with a color-neutral film at room temperature under thermal loading, which is suitable, for example, for wood bonding, particularly for hot bonding in the context of veneer production, and which at the same time reliably meets relevant test standards for cold-water resistance, such as EN 204/D3, for example.

It is an object of the present invention, therefore, to provide an adhesive composition whose bonds exhibit no discoloration within a wide temperature range and which, furthermore, also shows no discoloration when exposed to actinic radiation, and at the same time possesses a high cold-water resistance after application in hot bonding processes.

Polyvinyl ester dispersions have now been found, surprisingly, which allow this object to be achieved.

The present invention provides an aqueous polyvinyl ester dispersion comprising
a) at least one vinyl ester copolymer derived from at least one vinyl ester of a monocarboxylic acid, preferably a saturated aliphatic carboxylic acids, at least one ethylenically unsaturated monomer containing N-alkylol groups and/or derivatives of these groups, more particularly N-methylol groups, and, if desired, further comonomers,
b) at least one protective colloid,
c) at least one carboxylic acid and/or salt thereof, containing at least one further radical selected from the group consisting of hydroxyl, amino, carboxyl, carboxylic ester, and carboxylic amide radicals, and
d) at least one water-soluble salt with a divalent metal ion, more particularly with the metal ion of a metal from the second main or transition group of the Periodic Table of the Elements.

The inventive combination of the curing agents c) and d) in tandem with the specific vinyl ester copolymer a) leads, surprisingly, to high bond strengths of the adhesive bonds after cold-water exposure, and these bonds, even after severe temperature load and/or after severe load with actinic radiation, such as UV radiation, exhibit no discoloration tendency at all or else a discoloration tendency which is sharply reduced by comparison with conventional systems.

Consequently the polyvinyl ester dispersions of the invention are particularly suitable as a basis for veneer adhesives.

Suitable as a monomer basis for the vinyl ester copolymer a) are, in principle, the following groups of monomers:

One group is formed by vinyl esters of monocarboxylic acids having one to eighteen carbon atoms, examples being vinyl formate, vinyl acetate, vinyl propionate, vinyl isobutyrate, vinyl valerate, vinyl pivalate, vinyl 2-ethylhexanoate, vinyl decanoate, isopropenyl acetate, vinyl esters of saturated branched monocarboxylic acids having 5 to 15 carbon atoms in the acid radical, especially vinyl esters of the Versatic™ acids, vinyl esters of relatively long-chain saturated or unsaturated fatty acids such as, for example, vinyl laurate, vinyl stearate, and also vinyl esters of benzoic acid and of substituted derivatives of benzoic acid, such as vinyl p-tert-butylbenzoate. Of these, however, vinyl acetate as a principal monomer is particularly preferred.

One group of comonomers which can be used in addition to the vinyl esters is formed by aliphatic, monoolefinically or diolefinically unsaturated, optionally halogen-substituted hydrocarbons, such as ethene, propene, 1-butene, 2-butene, isobutene, conjugated C₄-C₈ dienes, such as 1,3-butadiene, isoprene, chloroprene, vinyl chloride, vinylidene chloride, vinyl fluoride or vinylidene fluoride.

A further group of comonomers is formed by esters of α,β-ethylenically unsaturated monocarboxylic or dicarboxylic acids, especially esters of α,β-ethylenically unsaturated C₃-C₈ monocarboxylic or dicarboxylic acids with preferably C₁-C₁₈ alkanols and especially C₁-C₈ alkanois or C₅-C₈ cycloalkanols. The esters of the dicarboxylic acids may be monoesters or, preferably, diesters. Suitable C₁-C8 alkanols are, for example, methanol, ethanol, n-propanol, isopropanol, 1-butanol, 2-butanol, isobutanol, tert-butanol, n-hexanol, and 2-ethylhexanol. Suitable cycloalkanols are, for example, cyclopentanol or cyclohexanol. Examples are esters of acrylic acid, of methacrylic acid, of crotonic acid, of maleic acid, of itaconic acid, citraconic acid or of fumaric acid, such as methyl (meth)acrylate, ethyl (meth)acrylate, isopropyl (meth)acrylate, n-butyl (meth)acrylate, isobutyl (meth)acrylate, 1-hexyl (meth)acrylate, tert-butyl (meth)acrylate, 2-ethylhexyl (meth)acrylate, di-n-methyl maleate or fumarate, di-n-ethyl maleate or fumarate, di-n-propyl maleate or fumarate, di-n-butyl maleate or fumarate, diisobutyl maleate or fumarate, di-n-pentyl maleate or fumarate, di-n-hexyl maleate or fumarate, dicyclohexyl maleate or fumarate, di-n-heptyl maleate or fumarate, di-n-octyl maleate or fumarate, di(2-ethylhexyl) maleate or fumarate, di-n-nonyl maleate or fumarate, di-n-decyl maleate or fumarate, di-n-undecyl maleate or fumarate, dilauryl maleate or fumarate, dimyristyl maleate or fumarate, dipalmitoyl maleate, or fumarate, di-stearyl maleate or fumarate, and diphenyl maleate or fumarate.

One further group of comonomers is formed by the alkenylaromatics. These are monoalkenylaromatics. Examples are styrene, vinyltoluene, vinylxylene, α-methylstyrene, and o-chlorostyrene.

The stated monomers generally form the principal monomers which, in relation to the total amount of the monomers to be polymerized by the process of free-radical aqueous polymerization, normally account for a fraction of more than 50% by weight, preferably more than 75%.

The monomers are preferably to be selected so as to form a copolymer having adhesive properties, preferably for wood. This can be done by conventionally setting the glass transition temperature of the resulting polymers.

In addition to the stated principal monomers, the vinyl ester copolymer also has at least structural units which are derived from ethylenically unsaturated monomers containing N-alkylol groups and/or derivatives thereof, in particular from N-methylol units. The fraction of the comonomers derived from these structural units is typically not more than 20% by weight, preferably not more than 10% by weight, and more preferably between 0.1% and 5% by weight, based on the total amount of the monomers.

Examples of ethylenically unsaturated monomers containing N-alkylol units, especially N-methylol units, are N-alkylol derivatives of amides of ethylenically unsaturated monocarboxylic or dicarboxylic acids, preferably of acrylic acid or of methacrylic acid. Preferred examples of such monomers are N-methylolacrylamide, N-methylolmethacrylamide, N-methylolallylcarbamate, N-ethylolacrylamide, N-propylolacrylamide, N-butylolacrylamide or dialkoxyhydroxyethylacrylamide. In addition it is also possible to use derivatives of N-methylol compounds, such as their esters, ethers or Mannich bases. N-methylol esters, N-methylolalkyl ethers or Mannich bases of N-methylolacrylamide or of N-methylolmethacrylamide or of N-methylolallylcarbamate, or the alkyl ethers of dialkoxyhydroxyethylacrylamide.

In addition it is also possible in the copolymerization to use further comonomers which modify the properties in a targeted way.

These further comonomers are present only optionally and are normally copolymerized only as what are called auxiliary monomers, as modifying monomers in amounts, based on the total amount of the monomers to be polymerized, of less than 50% by weight, generally of less than 20%, and preferably at less than 10% by weight.

These monomers may serve for further stabilization of the dispersions, by, for example, improving the film cohesion or other properties by crosslinking during the polymerization or during film formation. It is, however, also possible in this way to set other desired properties in a targeted manner.

Monomers which may serve for further stabilization are, in general, monomers which have an acid function, and/or salts thereof. This group includes, for example, α,β-monoethylenically unsaturated monocarboxylic and dicarboxylic acids having 3 to 10 carbon atoms, ethylenically unsaturated sulfonic acids, ethylenically unsaturated phosphonic acids, and their water-soluble salts, such as their sodium salts. Preferred monomers from this group are vinylsulfonic acid and its alkali metal salts, acrylamidopropanesulfonic acid and its alkali metal salts, ethylenically unsaturated C₃-C₈ carboxylic acids and C₄-C₈ dicarboxylic acids, such as maleic acid, fumaric acid, itaconic acid, crotonic acid, vinylacetic acid, acrylamidoglycolic acid, and, in particular, acrylic acid and methacrylic acid.

Examples of crosslinking auxiliary monomers are monomers containing two or more vinyl radicals, monomers containing two or more vinylidene radicals, and monomers containing two or more alkenyl radicals. Particularly advantageous in this context are the diesters of dihydric alcohols with α,β-monoethylenically unsaturated monocarboxylic acids, among which acrylic and methacrylic acid are preferred; the diesters of dibasic carboxylic acids with ethylenically unsaturated alcohols; other hydrocarbons having two ethylenically unsaturated groups; or the diamides of difunctional amines with α,β-monoethylenically unsaturated monocarboxylic acids.

Examples of monomers of this kind containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates or dimethylacrylates and ethylene glycol diacrylates or dimethacrylates, 1,2-propylene glycol dimethacrylate, 1,3-propylene glycol dimethacrylate, 1,3-butylene glycol dimethacrylate, 1,4-butylene glycol dimethacrylates, hexanediol diacrylate, pentaerythritol diacrylate, pentaerythritol diacrylate, and also divinylbenzene, vinyl methacrylate, vinyl acrylate, vinyl crotonate, allyl methacrylate, allyl acrylate, diallyl maleate, diallyl fumarate, diallyl phthalate, cyclopentadienyl acrylate, divinyl adipate or methylenebisacrylamide.

It is, however, also possible to use monomers having more than two double bonds, examples being tetraallyloxyethane, trimethylolpropane triacrylate, and triallyl cyanurate.

Further possible auxiliary monomers are monomers with N-functional groups that are different from N-alkylol groups, especially methylol groups or derivatives thereof. They include, for example, (meth)acrylamide, allylcarbamate, acrylonitrile, meth-acrylonitrile, acrylamidoglycolic acid, acrylamidomethoxyacetic acid methyl ester, N-(2,2-dimethoxy-1-hydroxyethyl)acrylamide, N-dimethylaminopropyl(meth)acrylamide, N-methyl(meth)acrylamide, N-butyl(meth)acrylamide, N-cyclohexyl(meth)acrylamide, N-dodecyl(meth)acrylamide, N-benzyl(meth)acrylamide, p-hydroxyphenyl(meth)-acrylamide, N-(3-hydroxy-2,2-dimethylpropyl)methacrylamide, ethylimidazolidone (meth)acrylate, N-(meth)acryloyloxyethylimidazolidin-1-one, N-(2-methacrylamido-ethyl)imidazolin-2-one, N-[(3-allyloxy-2-hydroxypropyl)aminoethyl]imidazolin-2-one, N-vinylformamide, N-vinylpyrrolidone or N-vinylethyleneurea.

One further group of auxiliary monomers is formed by hydroxy-functional monomers, such as the C₁-C₉ hydroxyalkyl esters of acrylic acid or of methacrylic acid, such as n-hydroxyethyl, n-hydroxypropyl or n-hydroxybutyl acrylate and methacrylate, and also their adducts with ethylene oxide or propylene oxide.

One further group of auxiliary monomers is formed by those which are self-crosslinking or crosslinkable via carbonyl groups. Examples are diacetoneacrylamide, allyl acetoacetate, vinyl acetoacetate and acetoacetoxyethyl acrylate or methacrylate.

One further group of auxiliary monomers is composed of monomers containing silane groups, examples being vinyltrialkoxysilanes, such as vinyltrimethoxysilane, vinyltriethoxysilane, alkylvinyldialkoxysilanes or (meth)acryloyloxyalkyltrialkoxysilanes, e.g., (meth)acryloyloxyethyltrimethoxysilane, or (meth)acryloyloxypropyltrimethoxysilane.

One further group of auxiliary monomers is composed of monomers containing epoxy groups, such as, for example, allyl glycidyl ether, methacryloyl glycidyl ether, butadiene monoepoxides, 1,2-epoxy-5-hexene, 1,2-epoxy-7-octene, 1,2-epoxy-9-decene, 8-hydroxy-6,7-epoxy-1 -octene, 8-acetoxy-6,7-epoxy-1-octene, N-(2,3-epoxy)propylacrylamide, N-(2,3-epoxy)propylmethacrylamide, 4-acrylamidophenyl-glycidyl ether, 3-acrylamidophenylglycidyl ether, 4-methacrylamidophenyl-glycidyl ether, 3-methacrylamidophenylglycidyl ether, N-glycidyloxymethylacrylamide, N-glycidyloxypropylmethacrylamide, N-glycidyloxyethylacrylamide, N-glycidyloxyethyl-methacrylamide, N-glycidyloxypropylacrylamide, N-glycidyloxypropylmethacrylamide, N-glycidyloxybutylacrylamide, N-glycidyloxybutylmethacrylamide, 4-acrylamidomethyl-2,5-dimethylphenyl glycidyl ether, 4-methacrylamidomethyl-2,5-dimethylphenyl glycidyl ether, acrylamidopropyldimethyl(2,3-epoxy)propylammonium chloride, methacrylamidopropyldimethyl(2,3-epoxy)propylammonium chloride and glycidyl methacrylate.

Besides vinyl ester copolymers the dispersions of the invention comprise protective colloids. These are polymeric compounds which are present during the emulsion polymerization and which stabilize the dispersion.

Suitable protective colloids are, for example, polyvinyl alcohols, polyalkylene glycols, alkali metal salts of polyacrylic acids and polymethacrylic acids, cellulose derivatives, starch derivatives, and gelatin derivatives, or polymers derived from acrylic acid, methacrylic acid, maleic acid, maleic anhydride, methyl vinyl ether, styrene, 2-acrylamido-2-methylpropanesulfonic acid and/or 4-styrenesulfonic acid, and the alkali metal salts thereof, and also polymers derived from N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amino-bearing acrylates, methacrylates, acrylamides and/or methacrylamides. A comprehensive description of further suitable protective colloids is found in Houben-Weyl, Methoden der organischen Chemie, volume XIV/1, Makromolekulare Stoffe [Macromolecular Compounds], Georg-Thieme-Verlag, Stuttgart, 1961, pages 411 to 420.

A preferred protective colloid is polyvinyl alcohol.

Where the protective colloids comprise polyvinyl alcohol, use is made in particular of polyvinyl alcohol with a degree of hydrolysis of 60-100 mol %, preferably 70 to 98 mol %, and with viscosities of the 4% strength by weight aqueous solutions at 20° C. of 2 to 70 mpa*s, or mixtures of these types. Besides “homopolymeric” polyvinyl alcohol, i.e., polyvinyl alcohol composed only of vinyl alcohol groups and residual vinyl acetate groups, it is possible to use copolymeric and/or functionalized polyvinyl alcohols, examples being reaction products of the polyvinyl alcohol with diketene or with polyvinyl alcohol types which carry carboxyl groups, thiol groups, formamido groups, amino groups, arylamino groups, sulfate groups, sulfonate groups, phosphonate groups, quaternary ammonium groups, and other functional groups.

Based on the solids fraction of the aqueous polyvinyl ester dispersion, the fraction of the protective colloids is preferably 1% to 35% by weight, especially 2% to 20% by weight.

In addition to the protective colloids, the aqueous polyvinyl ester dispersion may also be stabilized with emulsifiers. These may be ionic, preferably anionic, or, in particular nonionic wetting agents. A compilation of suitable emulsifiers is found in Houben-Weyl, Methoden der organischen Chemie, volume XIV/1, Makromolekulare Stoffe, Georg-Thieme-Verlag, Stuttgart, 1961, pp. 192-208).

The fraction of the emulsifiers can be up to 10% by weight, based on the solids fraction of the polymer dispersion. Emulsifiers may be present as early as during the polymerization and/or added thereafter.

Preference is given to using protective colloid-stabilized aqueous polyvinyl ester dispersions with an ionic and/or nonionic emulsifier content of 0% to 2% by weight, based on the solids fraction of the aqueous polyvinyl ester dispersion.

As component c) the polyvinyl ester dispersions of the invention contain at least one carboxylic acid and/or salt thereof with at least one further heterofunctional group.

The compounds of component c) may be aliphatic, cycloaliphatic, aromatic or heteroaromatic compounds.

Preferred components c) are hydroxycarboxylic acids, polycarboxylic acids, preferably di-, tri- or tetracarboxylic acids, aminocarboxylic acids or salts thereof.

Particularly preferred components c) are polycarboxylic acids or hydroxycarboxylic acids. They are selected in particular from the group consisting of oxalic acid, malonic acid, succinic acid, agaricic acid, citric acid, 1,2,3-propanetricarboxylic acid, hemimellitic acid, trimellitic acid, trimesic acid, tartaric acid, malic acid, maleic acid, fumaric acid, itaconic acid, propanedicarboxylic acid, butanetricarboxylic acid, butanetetracarboxylic acid, phthalic acid, isophthalic acid, terephthalic acid, cyclohexanetetracarboxylic acid, hexanetricarboxylic acid, and the full salts and half-salts of these carboxylic acids.

The amount of component c) used is in general 0.05%-10% by weight, based on the polyvinyl ester dispersion, preferably 0.2%-5% by weight.

As component d) the polyvinyl ester dispersions of the invention comprise at least one water-soluble salt with a divalent metal ion, more particularly a metal ion of a metal of the second main or transition group of the Periodic Table of the Elements.

The term “water-soluble” refers for the purposes of this description to a solubility in water at 25° C. of at least 1 g/l.

Component d) may be a water-soluble salt of an alkaline earth metal, such as a magnesium, calcium or strontium salt, for example. Suitable water-soluble salts of a metal of the second transition group include principally salts of zinc. Further possible salts with divalent metal ions derive from divalent tin, manganese or iron.

When selecting the metal salt d) it should be ensured that the metal salt has virtually no inherent color, and with particular preference is colorless.

Very particular preference is given to water-soluble magnesium salts and/or zinc salts.

Salts with any desired anions can be used, provided they are water-soluble salts.

Examples of salts are halides or carboxylates of alkaline earth metals, more particularly of magnesium, or of zinc.

The amount of component d) used (calculated as anhydrous active substance) is generally 0.05%-10% by weight of the polyvinyl ester dispersion, preferably 0. 1% -5% by weight.

The aqueous polyvinyl ester dispersion of the invention may comprise further customary additives which are typically used in adhesive formulations. These include, for example, film-forming assistants for lowering the minimum film formation temperature (MFFT reducers), plasticizers, buffers, pH modifiers, dispersants, defoamers, fillers, dyes, pigments, silane coupling agents, thickeners, viscosity regulators, solvents and/or preservatives.

One group of additives is represented by further crosslinking compounds (external crosslinking agents), which may be added in low molecular mass form or as crosslinker resins. These compounds are able further to enhance the effect of water resistance, and may be used in the polyvinyl ester dispersions of the invention with the proviso that they do not adversely affect film discoloration.

Examples of suitable external crosslinking agents include phenol-formaldehyde resins, resorcinol-formaldehyde resins, melamine-formaldehyde resins, hydroxymethyl-substituted imidazolidinones or thioimidazolidi nones, hydroxymethyl-substituted pyrimidinones or hydroxymethyl-substituted triazinones or glycolurils or their self-condensation products or mixed condensates of two or more of the stated compounds, or a mixture of two or more of the stated compounds. Examples thereof include 1,3-bis(hydroxymethyl)-4-methoxy-4,5,5-trimethyl-2-imidazolidinone, N,N′-dimethylol-4-methoxy-5,5-dimethylpropyleneurea, N,N′,N″,N″′-tetrakis(hydroxymethyl)glycoluril, 4,5-dihydroxy- 1,3-bis(methoxymethyl)-2-imidazolidinone, 4,5-dihydroxy-1,3-bis(hydroxymethyl)imidazolidin-2-one, tetrahydro-1,3-bis(hydroxymethyl)-4-methoxy-5,5-dimethylpyrimidin-2(1H)-one, 4,5-dihydroxy-1,3-dimethylol-2-imidazolidinone, 4,5-dihydroxy-1,3-dimethyl-2-imidazolidinone, tetrahydro-1,3-bis(hydroxymethyl)-4-hydroxy-5,5-dimethyl-(1H)-pyrimidin-2-one (=1,3-dimethylol-4-methoxy-5,5-dimethylpropyleneurea), tetrahydro-1,3-bis(hydroxymethyl)-4-alkoxy-5,5-dimethyl-(1H)pyrimidin-2-one, and N,N′,N″,N″′-tetrakis(hydroxymethyl)glycoluril. Preference is likewise given to the partially or fully etherified resins mentioned in EP-A 1 505 085 that are based on methylolated ethyleneureas, propyleneureas, glyoxaldiureas, malonaldehydediureas or combinations thereof.

An additionally outstandingly suitable group of external crosslinking agents is represented by polyaldehydes, such as aromatic hydrocarbons having two to six aldehyde groups, cycloaliphatic hydrocarbons having two to six aldehyde groups, dialdehyde starches or other water-soluble polyaldehydes, and also the at least partly masked polyaldehydes of EP-A-686 682. Further outstandingly suitable external crosslinking agents are free or at least partly masked polyisocyanates. These compounds are able, in combination with the vinyl ester copolymers used in accordance with the invention, to contribute to a higher crosslinking density.

In one particularly preferred embodiment the aqueous polyvinyl ester dispersion of the invention is composed of the above-stated components a), b), c), and d) and, if desired, of further customary additives e) which are selected from the group of film-forming assistants for lowering the minimum film formation temperature, plasticizers, buffers, pH modifiers, dispersants, defoamers, fillers, dyes, pigments, silane coupling agents, thickeners, viscosity regulators, solvents, preservatives, further crosslinking compounds, and combinations of two or more of these additives.

Particular preference is given to aqueous polyvinyl ester dispersions comprising the above-stated components a), b), c), and d) and comprising further customary above-stated additives e), the crosslinking compounds being selected from the group consisting of phenol-formaldehyde resins, resorcinol-formaldehyde resins, melamine-formaldehyde resins, hydroxymethyl substituted imidazolid inones, hydroxymethyl-substituted thioimidazolidinones, hydroxymethyl-substituted pyrimidinones, hydroxymethyl-substituted triazinones, hydroxymethyl-substituted glycolurils or their self-condensation products, or mixed condensates of two or more of the stated compounds, polyaldehydes, at least partly masked polyaldehydes, free or at least partly masked polyisocyanates, and combinations of two or more of these crosslinking compounds.

The polyvinyl ester dispersions of the invention can be formulated as one-component or as multicomponent compositions. Preference is given to one-component compositions.

The polyvinyl ester dispersions of the invention possess an acidic pH. It is situated in a range in which the N-alkylol groups, more particularly N-methylol groups or derivatives thereof in the vinyl ester copolymer are capable of acid-catalyzed crosslinking reactions with constituents of the composition. This pH range is situated preferably between 2 and 6, more particularly between 2.5 and 4.5.

Customarily the additions of components c) and d) of the invention are already sufficient to adjust the pH within the suitable range. The addition of further acidic components is possible, provided they do not adversely affect the thermal color neutrality. Preference is given to using selected Lewis acids or organic or inorganic Brφnsted acids. Brφnsted acids of preferred suitability have a pKₐ of <2.5, examples being hydrochloric acid, sulfuric acid, nitric acid, perchloric acid, p-toluenesulfonic acid, especially phosphoric acid.

The solids content of the aqueous polyvinyl ester dispersion of the invention is preferably 20% to 70% by weight, especially 30% to 65% by weight.

The aqueous polyvinyl ester dispersion can be prepared under the customary continuous or batch procedures of free-radical emulsion polymerization.

The implementation of a free-radically initiated aqueous emulsion polymerization of ethylenically unsaturated monomers is something which has been described a host of times before and is therefore well known to a person skilled in the art (cf., e.g., Encyclopedia of Polymer Science and Engineering, Vol. 8, pages 659 to 677, John Wiley & Sons, Inc., 1987; D.C. Blackley, Emulsion Polymerisation, pages 155 to 465, Applied Science Publishers, Ltd., Essex, 1975; D. C. Blackley, Polymer Latices, 2^{nd} Edition, Vol. I, pages 33 to 415, Chapman & Hall, 1997; H. Warson, The Applications of Synthetic Resin Emulsions, pages 49 to 244, Ernest Bonn. Ltd.. London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969, and DE-A 40 03 422). It is typically accomplished by dispersing the ethylenically unsaturated monomers in an aqueous medium, frequently with accompanying use of dispersing assistants, and polymerizing them by means of at least free-radical polymerization initiator.

Water-soluble and/or oil-soluble initiator systems are employed in this context, such as peroxodisulfates, azo compounds, hydrogen peroxide, organic hydroperoxides or dibenzoyl peroxide. These can be used either by themselves or in combination with reducing compounds such as Fe(II) salts, sodium pyrosulfite, sodium hydrogensulfite, sodium sulfite, sodium dithionite, sodium formaldehyde sulfoxylate, ascorbic acid as a redox catalyst system.

The protective colloids and, where appropriate, emulsifiers can be added before or during the polymerization. An additional top-up of polymeric stabilizers and/or of emulsifiers is likewise possible. After the end of the polymerization, any further process steps, such as chemical and/or physical demonomerization, are carried out. This dispersion is then admixed, preferably after the end of the polymerization or, where appropriate, further process steps, with components c) and d). The addition of the components at earlier steps of operation during the preparation of the polyvinyl ester dispersion is also possible, however. Components c) and d) can also be added before, during or after the formulation with further formula-specific additives. The sequence here is not critical, but should be harmonized with the particular formula.

The aqueous polyvinyl ester dispersions of the invention can be processed, for example, to products with very high cold-water resistance in tandem with very good color stability of the adhesive bonds.

Adhesive compositions produced from the polyvinyl ester dispersions of the invention generally satisfy the test standard DIN EN 204 D3 and in many cases in fact exceed it.

In contrast to known adhesive systems, no discoloration is observed in adhesive bonds under heat and/or under the influence of actinic radiation.

The invention further provides for the use of the aqueous polyvinyl ester dispersion of the invention for adhesively bonding or coating any desired substrates, preferably porous and semiporous substrates.

The specific suitability of the aqueous polyvinyl ester dispersions of the invention lies in their use as a water-resistant adhesive in particular for cellulosic substrates such as wood, especially solid wood or wood-derived materials, examples being veneers, plywood, layered wood, laminated wood, synthetic-resin compressed wood, composite boards or wood fiber materials such as porous, diffusion-open, hard or medium-density wood fiberboard (MDF) or plastic-coated decorative wood fiberboard. The adhesive compositions are suitable for manual or mechanical application and also, in particular, for applications in which the bonded joints are cured by high-frequency alternating currents or hydraulic hot presses.

The specific suitability lies in the hot bonding of thin-walled, high-value face veneers or top veneers onto suitable board material.

Further example applications are the production of water-resistant bonds and coatings of paper, cardboard, including corrugated cardboard, foam, cement, leather, textile or compressed laminates, their use as binders for textiles and nonwovens (engineered fabrics) and also in textiles printing and as a textile finish, their use as binders for glass fibers, which are used, for example, for consolidating plastic tiles, moldings, and as insulating material, or as binders for ceramics.

The examples below serve to illustrate the invention. The parts and percentages indicated in the examples are given by weight, unless noted otherwise.

### Base Dispersion for Inventive Examples and Comparative Examples C1-C3

In a 10 l glass reactor unit with stirring device and feed facilities, a polymer dispersion with a solids content of 52% was first prepared, using 7% by weight (based on the weight of the total monomers) of partially hydrolyzed polyvinyl alcohol as stabilizer. The polyvinyl alcohol used contained 25% thereof with a degree of hydrolysis of 92 mol %, and 75% thereof with a degree of hydrolysis of 88 mol %.

First about 52% of the total amount of vinyl acetate used was polymerized with initiation by 0.02% (based on the total amount of the vinyl acetate) of ammonium peroxodisulfate, at a reaction temperature of 65° C. to 85° C. The remaining vinyl acetate was subsequently metered in, together with 0.5% by weight of methacrylic acid, and, in parallel therewith, an aqueous solution of 0.57% of N-methylolacrylamide was metered in. The sum of these monomers together formed 100%. During this phase an additonal 0.01% of ammonium peroxodisulfate (based on the total amount of the vinyl acetate) was metered in parallel with the other feeds, the reaction temperature was held at 78-82° C. by regulation of the feeds and by the jacket cooling, and the same amount of ammonium peroxodisulfate was added once again at the end of the feed. This was followed by demonomerization with tert-butyl hydroperoxide/sodium sulfoxylate at 60-80° C., and the addition of 0.5% (based on total monomer) of sodium acetate trihydrate as a buffer.

The pH was 5.2. The amount of residual monomeric vinyl acetate was 370 ppm. The viscosity was 35 200 mpa*s, measured with a Brookfield RV viscometer (spindle 6, 20 rpm, 23° C.).

### EXAMPLE 1 (INVENTIVE)

The base dispersion, defoamed beforehand, was formulated as follows:

| | |
|---|---|
| Base dispersion | 100 pbw |
| Butyldiglycol acetate | 2.1 pbw |
| Magnesium chloride * 6 H₂O | 1.6 pbw |
| in deionized water | 3.0 pbw |
| Citric acid monohydrate | 1.0 pbw |
| in deionized water | 1.0 pbw |

The resulting dispersion was adjusted with deionized water to a viscosity (Brookfield RV viscometer (spindle 6, 20 rpm, 23° C.)) of 13 750 mpa*s and had a pH of 3.0.

### EXAMPLE 2 (INVENTIVE)

The base dispersion, defoamed beforehand, was formulated as follows:

| | |
|---|---|
| Base dispersion | 100 pbw |
| Butyldiglycol acetate | 2.1 pbw |
| NaOH 10% strength | 2.3 pbw |
| Zinc(II) chloride | 2.1 pbw |
| in deionized water | 3.0 pbw |
| Citric acid monohydrate | 1.0 pbw |
| in deionized water | 1.0 pbw |

The resulting dispersion was adjusted with deionized water to a viscosity (Brookfield RV viscometer (spindle 6, 20 rpm, 23° C.)) of 9 600 mpa*s and had a pH of 3.0.

### COMPARATIVE EXAMPLE C1 (WITHOUT COMPONENT C))

The base dispersion, defoamed beforehand, was formulated as follows:

| | |
|---|---|
| Base dispersion | 100 pbw |
| Butyldiglycol acetate | 2.1 pbw |
| Magnesium chloride * 6 H₂O | 1.6 pbw |
| in deionized water | 3.0 pbw |
| 5% strength hydrochloric acid | 2.9 pbw |
| (to pH of about 3) | |

The resulting dispersion was adjusted with deionized water to a viscosity (Brookfield RV viscometer (spindle 6, 20 rpm, 23° C.)) of 13 450 mpa*s and had a pH of 3.0.

### COMPARATIVE EXAMPLE C2 (WITHOUT COMPONENT D))

The base dispersion, defoamed beforehand, was formulated as follows:

| | |
|---|---|
| Base dispersion | 100 pbw |
| Butyldiglycol acetate | 2.1 pbw |
| deionized water | 3.0 pbw |
| Citric acid monohydrate | 1.0 pbw |
| in deionized water | 1.0 pbw |

The resulting dispersion was adjusted with deionized water to a viscosity (Brookfield RV viscometer (spindle 6, 20 rpm, 23° C.)) of 12 950 mpa*s and had a pH of 2.9.

### COMPARATIVE EXAMPLE C3 (WITHOUT COMPONENTS c) AND d))

The base dispersion, defoamed beforehand, was formulated as follows:

| | |
|---|---|
| Base dispersion | 100 pbw |
| Butyldiglycol acetate | 2.1 pbw |
| deionized water | 3.0 pbw |
| 5% strength hydrochloric acid | 2.9 pbw |
| (to pH of about 3) | |

The resulting dispersion was adjusted with deionized water to a viscosity (Brookfield RV viscometer (spindle 6, 20 rpm, 23° C.)) of 13 450 mpa*s and had a pH of 3.0.

Using the products obtained in this way, standard bonds were made on beech at different temperatures, and a visual assessment was made of the thermal discoloration behavior at different temperatures.

### Determination of Wet Bond Strengths

The formulated dispersions were tested on beech test specimens (EN 205) in accordance with test standard DIN EN 204/D3, test sequence 3. In this test the resistance of the adhesive film to four-day cold-water exposure is tested. The first series of bonds was carried out initially at room temperature under the conditions set out in table 1.

TABLE 1
Conditions for standard bonding to DIN EN 204
D3, test sequence 3, at room temperature

| | |
|---|---|
| Glue application: | 150 ± 20 g/m², double-sided application |
| Open waiting time | 3 minutes |
| Closed waiting time: | 3 minutes |
| Pressing time: | 2 hours |
| Pressing pressure: | 0.7 ± 0.1 N/mm² |
| Number of test elements per | 10 |
| test sequence | |
| Testing after storage sequence | 7 days standard conditions*⁾ |
| to DIN EN 204 D4/5 | 4 days cold water |
| | Test in the wet state |
| Test temperature: | 23° C. ± 2° C. |
| Rate of advance: | 50 mm/min. |

Classification in durability class D3/3 was made for a tensile strength of >= 2 N/mm²
*> 23 ± 2° C. and 50 ± 5% relative humidity

In further series of experiments, the formulated dispersions were bonded hot to beech test specimens (EN 205) on a heatable hydraulic press, then cooled to room temperature and subsequently subjected, analogously, to storage sequence 3 in accordance with test standard DIN EN 204/D3. The hot bonding within the experimental series was carried out in each case at three different temperatures (100° C., 120° C., and 140° C.). The conditions for the bonds and the storage are set out in table 2.

TABLE 2
Conditions for hot bonding on a heatable hydraulic
press, based on DIN EN 204 D3, test sequence 3

| | |
|---|---|
| Glue application: | 150 ± 20 g/m² double-sided application |
| Open waiting time | 3 minutes (at room temperature) |
| Closed waiting time | 3 minutes (at room temperature) |
| Pressing temperature | 100, 120, 140° C. |
| Pressing time at test | 5 minutes |
| temperature | |
| Pressing pressure: | 0.7 ± 0.1 N/mm² |
| Number of test specimens per | 10 |
| test sequence | |
| Testing after storage sequence | 7 days standard conditions*⁾ |
| to DIN EN 204 D4/5: | 4 days cold water |
| | Test in the wet state |
| Test temperature: | 23° C. ± 2° C. |
| Rate of advance: | 50 mm/Min. |

Classification in durability class D3/3 was made for a tensile strength of >= 2 N/mm²
*> 23 ± 2° C. and 50 ± 5% relative humidity

### Test of Thermal Discoloration on Beech

Films of the formulated dispersions about 200 pm thick were drawn down onto a beech board using a 400 μm box-section coating bar. The films were first dried at room temperature for 24 h. The boards were then thermally treated in a forced-air drying cabinet for 5 minutes each at the stated test temperature (100, 120, 140° C.), after which they were cooled, and the discoloration was assessed visually.

Commercial adhesive dispersions of category D3, catalyzed with aluminum salts, would undergo discoloration under these conditions to dark brown above 100° C. and through to black from 140° C. onward.

The experimental results obtained are listed in table 3.

TABLE 3

| | Test | Wet bond | |
|---|---|---|---|
| | temperature | strength DIN EN | |
| Example | ° C. | 204 D3/3 (N/mm²) | Film discoloration |
| 1 | Room temp. | 1.7 | colorless |
| 2 | Room temp. | 1.5 | colorless |
| C1 | Room temp. | 0.1 | colorless |
| C2 | Room temp. | 0 | colorless |
| C3 | Room temp. | 0 | colorless |
| 1 | 100° C. | 3.4 | colorless |
| 2 | 100° C. | 2.3 | colorless |
| C1 | 100° C. | 1.6 | colorless |
| C2 | 100° C. | 1.8 | colorless |
| C3 | 100° C. | 0.9 | colorless |
| 1 | 120° C. | 3.3 | colorless |
| 2 | 120° C. | 3.8 | colorless |
| C1 | 120° C. | 1.4 | colorless |
| C2 | 120° C. | 2.1 | colorless |
| C3 | 120° C. | 0.9 | colorless |
| 1 | 140° C. | 5.3 | colorless |
| 2 | 140° C. | 5.1 | colorless |
| C1 | 140° C. | 2.3 | colorless |
| C2 | 140° C. | 3.5 | colorless |
| C3 | 140° C. | 1.9 | colorless |

From these results it is clear that there is a synergistic effect from the inventive combination of components c) and d), whereas the absence of at least one of these components leads to much more weakly pronounced bond strengths, as can be seen from comparative examples C1 to C3.

### Test of Thermal Discoloration on Prolonged Exposure on Different Wood Species

Films about 400 μm thick of the formulated dispersions were drawn down onto cut slices of different wood species, using an 800 μm box-section coating bar. The films, without drying were thermally treated in a forced-air drying cabinet at 90° C. for 45 minutes each, and then cooled, and the discoloration was assessed visually.

As comparative example C4, Mowilith® LDL 2555 W, commercial product of Celanese Emulsions GmbH, was used.

As comparative example C5, a commercially available competitor product in the form of a wood adhesive of durability group D3 was used, which is offered in the trade as being of low discoloration.

The results are listed in table 4.

TABLE 4
Discoloration on different wood species

| | Wood | |
|---|---|---|
| Example | species | Film discoloration |
| 2 | Maple | colorless |
| C4 | Maple | dark brown |
| C5 | Maple | ocher |
| 2 | Oak | ocher |
| C4 | Oak | dark brown |
| C5 | Oak | light brown |
| 2 | Ash | colorless |
| C4 | Ash | light brown |
| C5 | Ash | yellowish |
| 2 | Spruce | colorless |
| C4 | Spruce | dark brown |
| C5 | Spruce | ocher |
| 2 | Pine | colorless |
| C4 | Pine | dark brown |
| C5 | Pine | colorless |
| 2 | Larch | colorless |
| C4 | Larch | dark brown |
| C5 | Larch | colorless |
| 2 | Poplar | colorless |
| C4 | Poplar | dark brown |
| C5 | Poplar | gray |
| 2 | Meranti | colorless |
| C4 | Meranti | dark brown |
| C5 | Meranti | greenish |
| 2 | Limba | slightly yellowish |
| C4 | Limba | dark brown |
| C5 | Limba | light brown |

### Determination of UV and Light Stability

The formulated dispersions were applied using a 50 μm slotted coating bar to small pieces of the particular wood species used, and dried at room temperature for 12 hours. Thereafter half of the film was covered with aluminum foil and the wooden plate was irradiated for 2 hours in the NOVASOLTEST light stability tester from Heraeus (1000 watt lamp—in the wavelength range between 300 and 800 nm) without use of a filter. The distance between the lamp and the test specimen was 70 cm. The exposed halves of the film were assessed visually. The results obtained are given in table 5.

TABLE 5
Discoloration on different wood species after irradiation

| | Wood | |
|---|---|---|
| Example | species | Film discoloration |
| 2 | Beech | yellowish |
| C4 | Beech | brown |
| C5 | Beech | yellowish |
| 2 | Maple | colorless |
| C4 | Maple | brown |
| C5 | Maple | light brown |

1. An aqueous polyvinyl ester dispersion comprising
a) at least one vinyl ester copolymer derived from at least one vinyl ester of a monocarboxylic acid, at least one ethylenically unsaturated monomer containing N-alkylol groups and/or derivatives of these groups, and, if desired, further comonomers,
b) at least one protective colloid,
c) at least one carboxylic acid and/or salt thereof, containing at least one further radical selected from the group consisting of hydroxyl, amino, carboxyl, carboxylic ester, and carboxylic amide radicals, and
d) at least one water-soluble salt with a divalent metal ion.

2. The aqueous polyvinyl ester dispersion as claimed in claim 1, wherein the vinyl ester copolymer comprises copolymerized groups derived from ethylenically unsaturated monomers with N-alkylol groups, especially N-methylol groups, and present in an amount of 0.1% to 10% by weight, based on the total monomers.

3. The aqueous polyvinyl ester dispersion as claimed in claim 2, wherein the vinyl ester copolymer additionally comprises further structural units which derive from comonomers which are copolymerizable with vinyl esters and with ethylenically unsaturated monomers containing N-methylol groups, preferably structural units derived from acrylic esters and/or from methacrylic esters and/or from ethylenically unsaturated monocarboxylic or dicarboxylic acids and/or from ethylenically unsaturated sulfonic acids.

4. The aqueous polyvinyl ester dispersion as claimed in claim 1, wherein the protective colloid is polyvinyl alcohol.

5. The aqueous polyvinyl ester dispersion as claimed in claim 1, wherein component c) is selected from the group consisting of hydroxycarboxylic acids, dicarboxylic acids, tricarboxylic acids, tetracarboxylic acids, aminocarboxylic acids, and the salts of these acids.

6. The aqueous polyvinyl ester dispersion as claimed in claim 5, wherein the hydroxycarboxylic acid is citric acid or a salt of citric acid.

7. The aqueous polyvinyl ester dispersion as claimed in claim 1, wherein the water-soluble salt with a divalent metal ion is a salt with a metal ion of a metal from the second main or transition group of the Periodic Table, preferably a magnesium salt or a zinc salt, very preferably a magnesium halide or zinc halide or a magnesium carboxylate or zinc carboxylate.

8. The aqueous polyvinyl ester dispersion as claimed in claim 1, which has a solids content of 30%-65% by weight, wherein the vinyl ester copolymer contains 0.1% to 10% by weight, based on the total monomers, of structural units derived from comonomers containing N-methylol groups, especially structural units derived from N-methylolacrylamide and/or from N-methylolmethacrylamide, wherein the vinyl ester copolymer contains, if desired, up to 10% by weight, based on the total monomers, of structural units derived from comonomers containing carboxylic acid groups, especially structural units derived from acrylic acid and/or from methacrylic acid, and wherein the amount of the protective colloid, preferably of the polyvinyl alcohol, is 0.1% to 30% by weight, based on the entirety of all of the monomers used in preparing the polyvinyl ester.

9. The aqueous polyvinyl ester dispersion as claimed in claim 1, wherein the carboxylic acid of component c) is selected from the group consisting of oxalic acid, malonic acid, succinic acid, agaricic acid, citric acid, 1,2,3-propanetricarboxylic acid, hemimellitic acid, trimellitic acid, trimesic acid, tartaric acid, malic acid, maleic acid, fumaric acid, itaconic acid, propanedicarboxylic acid, butanetricarboxylic acid, butanetetracarboxylic acid, phthalic acid, isophthalic acid, terephthalic acid, cyclohexanetetracarboxylic acid, hexanetricarboxylic acid, and the full salts and half-salts of these carboxylic acids.

10. The aqueous polyvinyl ester dispersion as claimed in claim 1, which is composed of components a), b), c), and d) as claimed in claim 1 and, if desired, of further, customary additives e) which are selected from the group consisting of film-forming assistants for lowering the minimum film formation temperature, plasticizers, buffers, pH modifiers, dispersants, defoamers, fillers, dyes, pigments, silane coupling agents, thickeners, viscosity regulators, solvents, preservatives, further crosslinking compounds, and combinations of two or more of these additives.

11. The aqueous polyvinyl ester dispersion as claimed in claim 10, wherein the crosslinking compounds are selected from the group consisting of phenol-formaldehyde resins, resorcinol-formaldehyde resins, melamine-formaldehyde resins, hydroxymethyl substituted imidazol idi nones, hydroxymethyl-substituted thioimidazolidinones, hydroxymethyl-substituted pyrimidinones, hydroxymethyl-substituted triazinones, hydroxymethyl-substituted glycolurils or their self-condensation products, or mixed condensates of two or more of the stated compounds, polyaldehydes, at least partly masked polyaldehydes, free or at least partly masked polyisocyanates, and combinations of two or more of these crosslinking compounds.

12. The use of the aqueous polyvinyl ester dispersion as claimed in claim 1 for coating and/or adhesively bonding substrates, preferably porous and/or semiporous substrates.

13. The use as claimed in claim 12, wherein the porous or semiporous substrate is wood which is used preferably in the production of veneers.

14. The use of the aqueous polyvinyl ester dispersion as claimed in claim 1 as a binder for textiles, especially for nonwovens.

15. The use of the aqueous polyvinyl ester dispersion as claimed in claim 1 as a binder for glass fibers.
